(19) United States
(12) Patent Application Publication
(10) Pub. No.: US 2008/0210081 A1
(43) Pub. Date: Sep. 4, 2008

(54) Special Music Paper

(76) Inventor: Pil-han Lee, Incheon (KR)

Correspondence Address: BIRCH STEWART KOLASCH & BIRCH, PO BOX 747, FALLS CHURCH, VA, 22040-0747, US

(21) Appl. No.: 11/816,108

(22) PCT Filed: Dec. 8, 2005
(86) PCT No.: PCT/KR05/04198

§ 371 Date: Aug. 13, 2007

(30) Foreign Application Priority Data
Feb. 24, 2005 (KR) 20-2005-0005031

(51) Int. Cl. G09B 15/00

(52) U.S. Cl. 84/483.1

(57) ABSTRACT

The object of the present utility model is to replace the third line from the bottom line (or from the top line) of the music paper that consists of five black lines with a line in different color of form from the other four lines in order to improve the accuracy and the efficiency of reading the musical notes in the music paper. The different color or form is adopted in the said third line (hereinafter, it is called as a “Mid-line”.) so that certain musical notes may be easily identified. Therefore, when several complicated musical notes are indicated on three inner lines together—that is, second, third and fourth lines from the bottom or top line (hereinafter, it is called as “Inner-lines”)—of a music paper, the music performers can identify the correct positions of the respective musical notes immediately without confusion. The present utility model enables the music performers to play the musical instruments or sing songs more accurately without any mistake in terms of the musical pitches and beats. In particular, the present utility model helps the beginners who are not accustomed to read the musical notes to improve the musical capabilities by allowing them to read the notes easily.

### TECHNICAL FIELD

The present utility model relates to a special music paper in which the Mid-line is indicated by a color or format different from other four lines in order to easily and visually grasp a music paper at first glance. In particular, it relates to a music paper by which playing the instruments can be comfortable and interesting since the players can easily understand the scales at first glance in a case that the complicated scales are indicated across three Inner-lines, and rhythm/tone are identified more accurately, and in a case that a person sings a song according to a music paper. Even a beginner can play the musical scales without failures. Also, those who are not interested in the music can understand the music papers easily because they are not accustomed to the musical notes, and thereby the musical capabilities can be improved.

### BACKGROUND ART

Conventionally, the music papers which were used in playing various kinds of instruments comprising only five black lines, and musical notes and scales that are indicated by a black color in five lines. Therefore, when very complex musical notes are indicated in a music paper, there was a problem that playing was liable to be confused since it is difficult to identify correct positions of the musical scales of such complex musical notes in a moment and thus, there were much inconveniences. Further, when the musical scales are positioned on one of 2nd, 3rd and 4th Inner-lines, it is difficult for the beginners who are not so skilled in reading the musical notes to recognize them rapidly at a glance, and they could not play the scales correctly. When musical notes are added on an upper portion and a lower portion of the five lines, it also was difficult to read the scales swiftly.

### DISCLOSURE OF INVENTION

### Technical Problem

FIG. 1 is an example showing a conventional music paper that represents D-major musical scale.

But, as for the indicated part (a), it is difficult to recognize the correct pitch of each note at a glance when they are positioned on one of the 2nd, 3rd, and 4th Inner-lines.

### Technical Solution

Therefore, when a player tries to recognize the music paper comprising five lines, the Mid-line of the five lines is indicated in a color, or a format which is different from those of the other four lines, and a different color is used according to the length (speed) of the musical notes.

### ADVANTAGEOUS EFFECTS

When several complicated musical notes are indicated on three inner lines together—that is, second, third and fourth lines from the bottom or top line (hereinafter, it is called as “Inner-lines”)—of a music paper, the music performers can identify the correct positions of the respective musical notes immediately without confusion. The present utility model enables the music performers to play the musical instruments or sing songs more accurately without any mistake in terms of the musical pitches and beats.

In particular, the present utility model helps the beginners who are not accustomed to read the musical notes to improve the musical capabilities by allowing them to read the notes easily.

### BRIEF DESCRIPTION OF THE DRAWINGS

FIG. 1 is a view showing a conventional music paper.

FIG. 2 is a view showing a special music paper in which the Mid-line of five black lines is drawn differently from other four lines.

FIG. 3 is a view showing a special music paper in which a color of a head portion of the musical notes is drawn differently.

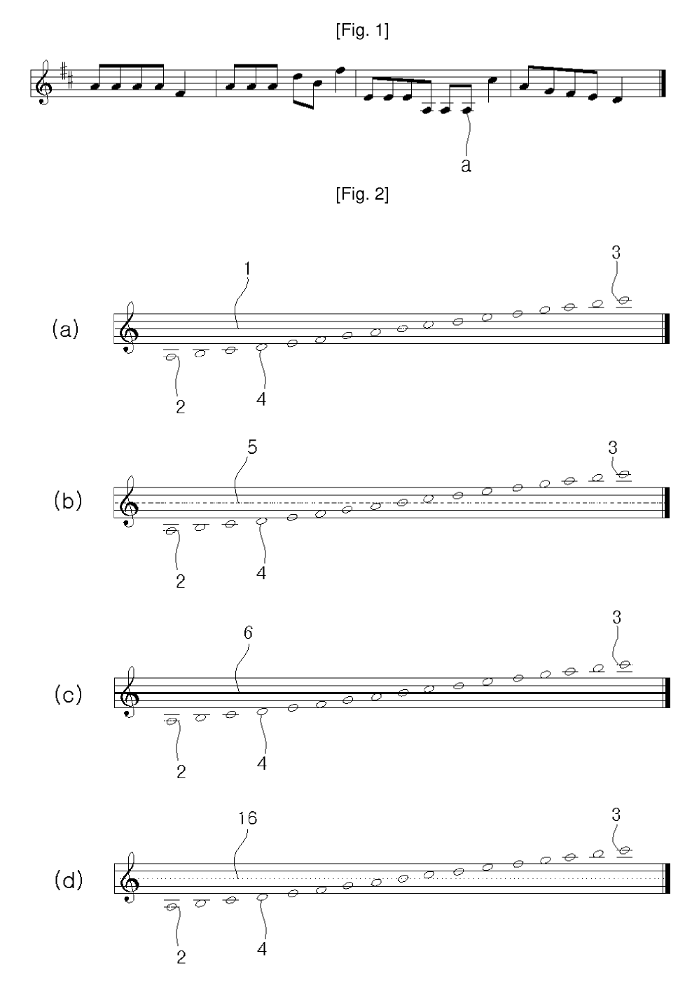

### BRIEF DESCRIPTION OF THE SYMBOLS OF THE IMPORTANT PORTIONS

2: lower leger line 3: upper leger line
4: whole note 7: quartet note
8: head portion of eighth note (red color)
9: head portion of sixteenth note (blue color)
10: head portion of thirty-second note (yellow color)
11: tail portion

### BEST MODE FOR CARRYING OUT THE INVENTION

In a music paper comprising five lines on which musical notes, scales and major (minor) keys are indicated, the Mid-line is indicated in a different color other than black, and the leger lines that fall into every 5th line from the Mid-line, whether above or below, are colored with the same color as the Mid-line. Further, it is preferable that the solid black Mid-line is replaced with a dotted line, or a thicker or a thinner line, or with a line having a different level of darkness from that of the other four lines.

### MODE FOR THE INVENTION

Brief explanations for the utility model are as follows.

FIG. 2a shows the Mid-line 1, the lower leger line 2, and an upper leger line 3 that are indicated with a red color, and the whole notes 4 in a special music paper.

When the basic musical scale is set to “C major”, the syllable name for the Mid-line 1 is “Si”, the syllable name for the leger line 2 below the staff 2 is “La”, and the syllable name for the leger line 3 above the staff 2 is “Do”.

Likewise, when the basic musical scale is set to “G major” (not shown in the figure), the syllable names for each line mentioned above become “Mi”, “Re” and “Fa”, respectively. In this way, the syllable names for the Mid-line, the leger line below or above the staff are preset and thus are quickly identifiable, depending on the basic musical scale.

FIG. 2b is another embodiment of FIG. 2a. In the FIG. 2b, the Mid-line 5 is now depicted as a dotted line, and the leger line 2 below the staff or the leger line 3 above the staff is colored in red as indicated in FIG. 2a. Further, in FIG. 2c, the Mid-line 5 is depicted as a line thicker than the other four lines as another embodiment of FIG. 2a. In FIG. 2d, the Mid-line 5 is indicated in light black, and since the explanation is same to that of the embodiment of FIG. 2a, it is omitted.

Therefore, the special music paper with the features illustrated in FIG. 2a-2d allows the music performers to identify the syllable names of each musical notes very easily and promptly.

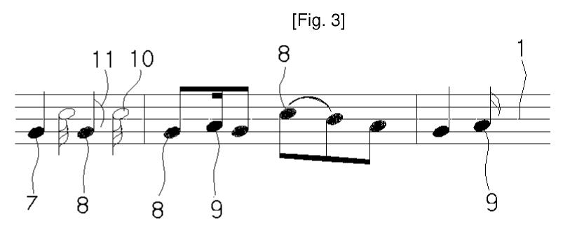

FIG. 3 shows a special music paper in which a color of a head portion of the musical notes is drawn differently according to the length of the musical notes, based on the embodiment of FIG. 2. Further, the Mid-line 1 is indicated with a red color.

In connection with length (speed) of a musical note, In a case that the one basic rhythm is set to a quarter note, the head portion 7 of a quarter note is indicated in black color, the head portion 8 of a eighth note (a tail portion is 1) is indicated in red color, the head portion 9 (a tail portion is 2) of a sixteenth note is indicated in blue color, and the head portion 10 of the thirty-second note (a tail portion is 3) is indicated in yellow color. Therefore, when judging the length of each musical notes, because it is possible to recognize the length of the musical note by identifying the colors of the head portion of the musical notes, the music performers can read the length of the musical note at a glance, as compared to a conventional method for judging the lengths of the musical notes in which, as a result of identifying the tail portion 11 of the musical note, when the tail portion is judged to be one, it is judged that the eighth note is depicted; when the tail portion is judged to be two, it is judged that the sixteenth note is depicted; and when the tail portion is judged to be three, it is judged that the thirty-second note is depicted.

As described above, it is possible to depict the head portion with other colors except above-mentioned colors.

### INDUSTRIAL APPLICABILITY

As described above, according to the present utility model, a music paper is described which is characterized in that when the music players sing a song or play the musics, they can recognize the rhythm and tones at a glance because the Mid-line, the leger line below the staff and the leger line above the staff are indicated in colors different from those of the other lines in order to improve a music paper which is indicated with only a black color.

Therefore, there are effect that even a beginner can read the music paper easily and the performers who are not familiar with the musical notes can play the instruments with interest and curiosity, thereby improving the musical capabilities. In addition, those who are majored in a music can read the music paper that includes diverse changes of the complicated musical notes in a moment without any mistakes.

1. a special music paper comprising five black lines with musical notes and scales, wherein a color of the Mid-line of a music paper is indicated by other color than a black color,
each of fifth lines from an upper portion and a lower portion of an of said Mid-line is indicated by a color which is same to the color of said third line. and a color of a head portion of the musical notes is indicated differently according to lengths of the musical notes described in said five black lines.

2. The special music paper according to the claim 1, wherein said Mid-line is indicated by a dotted line.

3. The special music paper according to the claim 1, wherein said Mid-line is indicated as a line having a different width as compared to other four lines.

4. The special music paper according to the claim 1, wherein said Mid-line is indicated as a line having a different depth of darkness as compared to other four lines.
